(19) United States
(12) Patent Application Publication
(10) Pub. No.: US 2022/0357698 A1
(43) Pub. Date: Nov. 10, 2022

(54) IMAGE FORMING APPARATUS, PRESSING FORCE CONTROL METHOD, AND NON-TRANSITORY COMPUTER-READABLE RECORDING MEDIUM ENCODED WITH PRESSING FORCE CONTROL PROGRAM

(71) Applicant: Konica Minolta, Inc., Tokyo (JP)

(72) Inventor: Hideki HADANO, Toyokawa-shi (JP)

(21) Appl. No.: 17/658,582

(22) Filed: Apr. 8, 2022

(30) Foreign Application Priority Data
May 10, 2021 (JP) 2021-080039

(51) Int. Cl. G03G 15/20

(52) U.S. Cl. CPC G03G 15/2064

(57) ABSTRACT

An image forming apparatus includes a pressure roller, a driver that drives the rotation of the pressure roller, an endless fuser belt, a pressing member that is provided inside of the fuser belt to be opposite to the pressure roller and forms a nip portion where the fuser belt and the pressure roller come into contact with each other, a adjustment mechanism that adjusts a pressing force that presses one of the pressure roller and the pressing member to the other, a detector that detects a rotational load of the fuser belt, and a pressing force controller that controls the adjustment mechanism such that the pressing force is higher in an overload state where the rotational load of the fuser belt is equal to or more than a predetermined value than in a normal state where the rotational load of the fuser belt is less than the predetermined value.

The entire disclosure of Japanese patent Application No. 2021-080039 filed on May 10, 2021, is incorporated herein by reference in its entirety.

### BACKGROUND

### Technological Field

The present invention relates to an image forming apparatus, a pressing force control method, and a non-transitory computer-readable medium encoded with a pressing force control program. In particular, the present invention relates to an image forming apparatus that pressurizes and heats a recording medium to fuse a toner on the recording medium, a pressing force control method executed in the image forming apparatus, and a non-transitory computer-readable recording medium encoded with a pressing force control program that causes a computer for controlling the image forming apparatus to execute the pressing force control method.

### Description of the Related art

A fuser device that pressurizes and heats paper on which an image constituted by a toner is formed, to fuse the toner on the paper is provided in an image forming apparatus such as a copying machine, a printer or a facsimile device. In this fuser device, it is required to efficiently fuse the toner on the paper in order to increase printing speed and reduce consumption energy. Therefore, the fuser device is required to reduce heat capacity and increase an area in contact with the paper.

JP 2020-46505 A, for example, describes an image forming apparatus that includes an endless fuser belt, a fuser member arranged on an inner periphery of the fuser belt, a pressure roller arranged on an outer periphery of the fuser belt to be opposite to the fuser member, a first motor that rotates the pressure roller, and a heater that heats the fuser belt. In the fuser device described in JP 2020-46505 A, a nip portion is formed between the fuser member and the pressure roller. Since the shape of the nip portion of the fuser member can be a shape having a curvature conforming to the shape of the pressure roller, the width of the nip portion of the fuser device can be larger.

In the fuser device described in JP 2020-46505 A, the fuser belt slides around the fuser member and, therefore, if the fuser device is used for a long period of time, abrasion powder gradually accumulates on the inner side of the fuser belt. Also, in a case where a lubricant is applied on the inner side of the fuser belt, the lubricant is reduced due to a long use of the fuser device. Thus, in some cases, when the fuser device enters the terminal stage of life after the long use, sliding resistance of the fuser belt is increased, a phenomenon called stick slip occurs in which the fuser belt that is driven to rotate relative to rotation of the pressure roller instantaneously repeats rotating and stopping, and abnormal noise is generated from the fuser device.

### SUMMARY

According to one aspect of the present invention, an image forming apparatus includes: a pressure roller; a driving unit that drives rotation of the pressure roller; an endless fuser belt; a pressing member that is provided inside of the endless fuser belt to be opposite to the pressure roller and forms a nip portion where the fuser belt and the pressure roller come into contact with each other; a pressing force adjustment mechanism that adjusts a pressing force that presses one of the pressure roller and the pressing member to the other; a detector that detects a rotational load of the fuser belt; and a pressing force controller that controls the pressing force adjustment mechanism such that the pressing force is higher in an overload state where the rotational load of the fuser belt detected by the detector is equal to or more than a predetermined value than in a normal state where the rotational load of the fuser belt is less than the predetermined value.

According to another aspect of the present invention, a pressing force control method is executed by an image forming apparatus, the image forming apparatus includes a pressure roller, a driving unit that drives rotation of the pressure roller, an endless fuser belt, a pressing member that is provided inside of the endless fuser belt to be opposite to the pressure roller and forms a nip portion where the fuser belt and the pressure roller come into contact with each other, and a pressing force adjustment mechanism that adjusts a pressing force that presses one of the pressure roller and the pressing member to the other, the method includes: a detection step of detecting a rotational load of the fuser belt; and a pressure step of controlling the pressing force adjustment mechanism such that the pressing force is higher in an overload state where the rotational load of the fuser belt detected by the detection step is equal to or more than a predetermined value than in a normal state where the rotational load of the fuser belt is less than the predetermined value.

According to still another aspect of the present invention, a non-transitory computer-readable recording medium is encoded with a pressing force control program executed by a computer that controls an image forming apparatus, the image forming apparatus includes a pressure roller, a driving unit that drives rotation of the pressure roller, an endless fuser belt, a pressing member that is provided inside of the endless fuser belt to be opposite to the pressure roller and forms a nip portion where the fuser belt and the pressure roller come into contact with each other, and a pressing force adjustment mechanism that adjusts a pressing force that presses one of the pressure roller and the pressing member to the other, and the pressing force control program causes the computer to execute a detection step of detecting a rotational load of the fuser belt, and a pressure step of controlling the pressing force adjustment mechanism such that the pressing force is higher in an overload state where the rotational load of the fuser belt detected by the detection step is equal to or more than a predetermined value than in a normal state where the rotational load of the fuser belt is less than the predetermined value.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing the appearance of a printer in one of the present embodiments;

FIG. 2 is a block diagram showing one example of a hardware configuration of the printer;

FIG. 3 is a cross sectional view showing one example of an internal structure of the printer;

FIG. 4 is a cross sectional view of a fuser device;

FIG. 5 is a first diagram showing a pressing force adjustment mechanism;

FIG. 6 is a second diagram showing the pressing force adjustment mechanism;

FIG. 7 is a diagram showing one example of a relationship between a cumulative number of printed sheets and a rotational load;

FIG. 8 is a block diagram showing one example of functions of a CPU included in a printer in a first embodiment;

FIG. 9 is a diagram showing one example of a relationship between a rotation speed and a pressing force of a pressure roller in the first present embodiment;

FIG. 10 is a diagram showing one example of a temporal relationship among pressure roller control, the pressing force, and a position of a paper in the first embodiment;

FIG. 11 is a first flowchart showing one example of a flow of a pressing force control process in the first embodiment;

FIG. 12 is a second flowchart showing the one example of the flow of the pressing force control process in the first embodiment;

FIG. 13 is a bock diagram showing one example of functions of a CPU included in a printer according to a second embodiment;

FIG. 14 is a diagram showing one example of a relationship between rotation speed and a pressing force of a pressure roller in a second embodiment;

FIG. 15 is a diagram showing one example of a temporal relationship among pressure roller control, the pressing force, and a position of a paper in the second embodiment;

FIG. 16 is a flowchart showing one example of a flow of a pressing force control process in the second embodiment; and

FIG. 17 is a flowchart showing one example of a flow of a low speed pressing force control process.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of the present invention will be described below with reference to the drawings. In the following description, the same parts are denoted with the same reference characters. Their names and functions are also the same. Thus, a detailed description thereof will not be repeated.

### First Embodiment

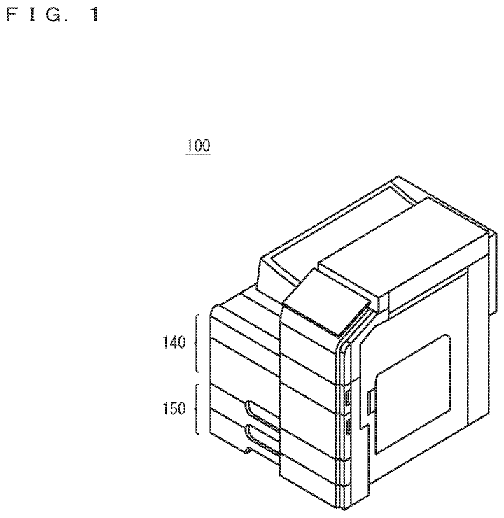

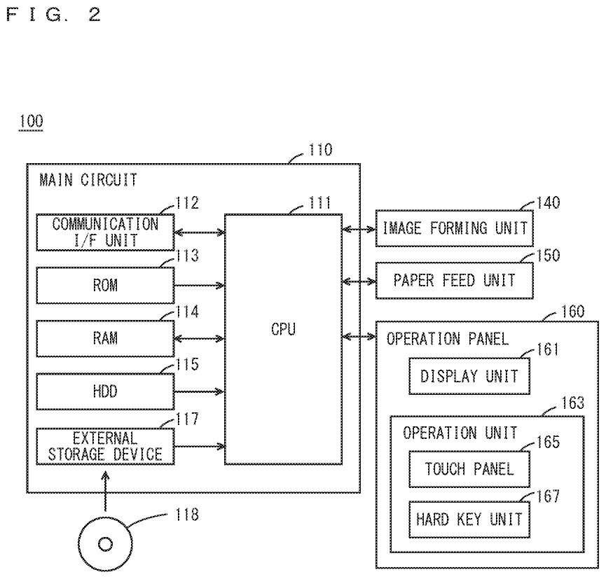

FIG. 1 is a first perspective view showing the appearance of a printer in one of the present embodiments. FIG. 2 is a block diagram showing one example of a hardware configuration of the printer. With reference to FIGS. 1 and 2, the printer 100 is one example of an image forming apparatus and includes a main circuit 110, an image forming unit 140 for forming an image on a paper or the like based on image data, a paper feeder 150 for supplying paper to the image forming unit 140, and an operation panel 160 serving as a user interface.

The main circuit 110 includes a CPU (Central Processing Unit) 111 for controlling the printer 100 as a whole, a communication interface (I/P) unit 112, a ROM (Read Only Memory) 113, a RAM (Random Access Memory) 114, a Hard Disc Drive (HDD) 115 that is used as a mass storage device, and an external storage device 117. The CPU 111 is connected to the image forming unit 140, the paper feeder 150 and the operation panel 160, and controls the entire printer 100.

The paper feeder 150 conveys paper stored in a paper feed cassette to the image forming unit 140. The image forming unit 140 is controlled by the CPU 111 to form an image by a well-known electrophotographic technique, forms an image on a paper conveyed by the paper feeder 150 based on the image data input from the CPU 111, and discharges the paper having the image formed thereon to a paper discharge tray 39. The image data output to the image forming unit 140 by the CPU 111 includes image data such as print data received from an external personal computer or the like.

The ROM 113 stores a program to be executed by the CPU 111 or data required for execution of the program. The RAM 114 is used as a work area when the CPU 111 executes a program.

The operation panel 160 is provided on an upper surface of the printer 100. The operation panel 160 includes a display unit 161 and an operation unit 163. The display unit 161 is a Liquid Crystal Display (LCD), for example, and displays an instruction menu for a user, information about acquired image data, etc. Any device that displays an image, for example, an organic EL (electroluminescence) display can be used instead of an LCD.

The operation unit 163 includes a touch panel 165 and a hard key unit 167. The hard key unit 167 includes a plurality of hard keys. The hard keys are contact switches, for example. The touch panel 165 detects a position designated by the user on a display surface of the display unit 161.

The communication I/F unit 112 is an interface for connecting the printer 100 to a network. The communication I/F unit 112 communicates with another computer connected to the network using a communication protocol such as TCP (Transmission Control Protocol) or UDP (File Datagram Protocol). The network to which the communication I/F unit 112 is connected is a Local Area Network (LAN), either wired or wireless. Further, the network is not limited to the LAN and may be a Wide Area Network (WAN), a Public Switched Telephone Network (PSTN), the Internet or the like.

The external storage device 117 is controlled by the CPU 111 and mounted with a CD-ROM (Compact Disk Read Only Memory) 118 or a semiconductor memory. While the CPU 111 executes a program stored in the ROM 113 by way of example in the present embodiment, the CPU 111 may control the external storage device 117, read out a program to be executed by the CPU 111 from the CD-ROM 118, and store the read program in the RAM 114 for execution.

It is noted that a recording medium for storing the program executed by the CPU 111 is not limited to the CD-ROM 118. It may be a flexible disc, a cassette tape, an optical disc (MO (Magnetic Optical Disc)/MD (Mini Disc)/DVD (Digital Versatile Disc)), an IC card, an optical card, and a medium such as a semiconductor memory such as a mask ROM and an EPROM (Erasable Programmable ROM). Further, the CPU 111 may download a program from a computer connected to the network to store the program in the HDD 115, or the computer connected to the network may write the program in the HDD 115. Then, the program stored in the HDD 115 may be loaded into the RAM 114 to be executed by the CPU 111. The program referred to here includes not only a program directly executable by the CPU 111 but also a source program, a compressed program, an encrypted program and the like.

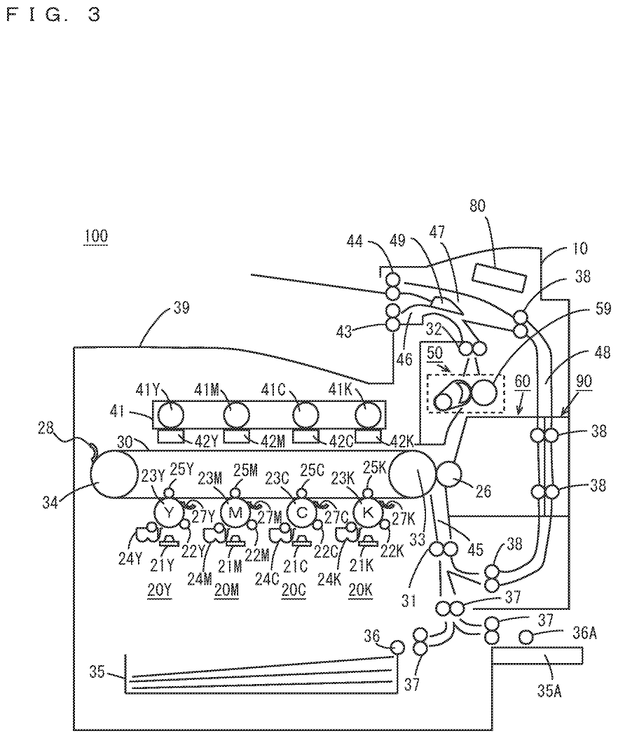

FIG. 3 is a cross sectional view schematically showing one example of an internal structure of the printer. In the following, in FIG. 3, a right and left direction refers to a right-and-left direction and a front and back direction refers to a depth direction. A direction from the left to the right in the right-and-left direction refers to a right side direction, and a direction from the right to the left refers to a left side direction. A direction from the front to the back in the depth direction refers to a front side direction, and a direction from the back to the front refers to a back side direction.

The printer 100 includes image forming units 20Y, 20M, 20C, 20K for respective yellow, magenta, cyan, and black. Here, “Y,” “M,” “C,” and “K” represent yellow, magenta, cyan, and black, respectively. At least one of the image forming units 20Y, 20M, 20C, 21K is driven, so that an image is formed. When all of the image forming units 20Y, 20M, 20C, 21K are driven, a full color image is formed. Printing data pieces for yellow, magenta, cyan and black are respectively input to the image forming units 20Y, 20M, 20C, 21K. The only difference among the image forming units 20Y, 20M, 20C, 21K is the color of toner used by the image forming units 20Y, 20M, 20C, 21K. Therefore, the image forming unit 20Y for forming an image in yellow will now be described.

The image forming unit 20Y includes an exposure device 21Y to which printing data for yellow is input, a photoreceptor drum 23Y which is an image carrier, a charging roller 22Y for uniformly charging a surface of the photoreceptor drum 23Y, developer 24Y, a first transfer roller 25Y for transferring a toner image formed on the photoreceptor drum 23Y onto an intermediate transfer belt 30 as an image carrier by the action of electric field force, a drum cleaning blade 27Y for removing transfer residual toner on the photoreceptor drum 23Y, a toner bottle 41Y, and a toner hopper 42Y.

The toner bottle 41Y stores a yellow toner. The toner bottle 41Y is rotated by a toner bottle motor as a driving source to discharge the toner outside. The toner discharged from the toner bottle 41Y is supplied to the toner hopper 42Y. The toner hopper 42Y supplies the toner to the developer 24Y in response to the remaining amount of toner stored in the developer 24Y reaching a predetermined lower limit value or less.

The charging roller 22Y, the exposure device 21Y, the developer 24Y, the first transfer roller 25Y, and the drum cleaning blade 27Y are arranged in this order around the photoreceptor drum 23Y in a rotation direction of the photoreceptor drum 23Y.

After being electrically charged by the charging roller 22Y, the photoreceptor drum 23Y is irradiated with laser light emitted by the exposure device 21Y. The exposure device 21Y exposes an image corresponding portion of a surface of the photoreceptor drum 23Y to form an electrostatic latent image. Thus, the electrostatic latent image is formed on the photoreceptor drum 23Y. Then, the developer 24Y develops the electrostatic latent image formed on the photoreceptor drum 23Y by the charged toner. Specifically, the toner is applied onto the electrostatic latent image formed on the photoreceptor drum 23Y by the action of electric field force, so that a toner image is formed on the photoreceptor drum 23Y. The toner image formed on the photoreceptor drum 23Y is transferred onto the intermediate transfer belt 30 as the image carrier by the action of electric field force by the first transfer roller 25Y. The untransferred toner remaining on the photoreceptor drum 23Y is removed from the photoreceptor drum 23Y by the drum cleaning blade 27Y.

On the other hand, the intermediate transfer belt 30 is suspended by a driving roller 33 and a driven roller 34 so as not to be loosened. When the driving roller 33 rotates in a counterclockwise direction in FIG. 2, the intermediate transfer belt 30 rotates at a predetermined speed in the counterclockwise direction in FIG. 2. The driven roller 34 rotates in the counterclockwise direction with the rotation of the intermediate transfer belt 30.

Thus, the image forming units 20Y, 20M, 20C, 20K sequentially transfer toner images onto the intermediate transfer belt 30. Timing for transferring the toner images onto the intermediate transfer belt 30 by the respective image forming units 20Y, 20M, 20C, 20K is adjusted by detection of a reference mark provided on the intermediate transfer belt 30. Thus, toner images in yellow, magenta, cyan and black are superimposed on the intermediate transfer belt 30.

The toner image formed on the intermediate transfer belt 30 is transferred onto a paper by the action of electric field force by a second transfer roller 26 as a transfer member. A paper conveyed by a timing roller 31 is conveyed to a nip portion where the intermediate transfer belt 30 and the second transfer roller 26 are in contact with each other. The paper onto which the toner image has been transferred is conveyed to the fuser device 50, heated, and pressurized by the fuser device 50. Thus, the toner is melted and fused onto the paper. Thereafter, the paper is discharged to the paper discharge tray 39.

The belt cleaning blade 28 is provided upstream of the image forming unit 20Y of the intermediate transfer belt 30. The belt cleaning blade 28 removes the toner which has not been transferred onto the paper and remains on the intermediate transfer belt 30.

The printer 100 drives all of the image forming units 20Y, 20M, 20C, 20K in the case of forming a full-color image, whereas the printer 100 drives any one of the image forming units 20Y, 20M, 20C, 20K in the case of forming a monochrome image. Also, two or more of the image forming units 20Y, 20M, 20C, 20K can be combined to form an image. While an example is described in which the printer 100 adopts a tandem system that includes the image forming units 20Y, 20M, 20C, 20K that respectively form toner of four colors on a paper, the printer 100 may adopt a four cycle system in which toner of four colors are transferred onto a paper in sequence by one photoreceptor drum.

A plurality of sheets of paper are set in a paper feed cassette 35. The papers stored in the paper feed cassette 35 are supplied one by one in sequence to a feeding path by a take-out roller 36 attached to the paper feed cassette 35 and are then conveyed to the timing roller 31 by a paper feed roller 37. In a case where one or more papers are set in a manual feed cassette 35A, the one or more papers set in the manual feed cassette 35A are supplied one by one in sequence to the feeding path by a take-out roller 36A attached to the manual feed cassette 35A and are then conveyed to the timing roller 31 by the paper feed roller 37.

The feeding path for papers includes an image forming path 45, a first conveying path 46, a second conveying path47, and a front and back inversion path 48. The image forming path 45 is a path extending from the timing roller 31 to a path switching gate 49, and the timing roller 31, the second transfer roller 26, and the fuser device 50 are arranged in this order in the image forming path 45. The timing roller 31 feeds the papers conveyed from the paper feed cassette 35 or the manual feed cassette 35A to the image forming path 45. The timing roller 31 starts conveying a paper such that the paper arrives at the second transfer roller 26 at a point in time at which a toner image formed on the intermediate transfer belt 30 arrives at the second transfer roller 26. The paper conveyed by the timing roller 31 is pressed against the intermediate transfer belt 30 by the second transfer roller 26. Thus, toner images in yellow, magenta, cyan and black that are formed on the intermediate transfer belt 30 in a superimposed manner are transferred to the paper.

The paper conveyed by the second transfer roller 26 is conveyed to the fuser device 50. The fuser device 50 heats and pressurizes the paper. Thus, the toner is fused to the paper. Then, the paper is conveyed to either one of the first conveying path 46 and the second conveying path 47 by the path switching gate 49.

The first conveying path 46 is a path extending from the path switching gate 49 to a paper discharge roller 43. Thereafter, the paper conveyed to the first conveying path 46 is discharged onto the paper discharge tray 39 by the paper discharge roller 43.

The second conveying path 47 is a path extending from the path switching gate 49 to an inversion roller 44. The second conveying path 47 is connected to the image forming path 45 and the front and back inversion path 48 at the path switching gate 49. The paper entering the second conveying path 47 from the path switching gate 49 is conveyed to the inversion roller 44. The inversion roller 44 performs three operations: a waiting operation, an inversion operation, and a paper discharging operation. When performing the waiting operation, the inversion roller 44 rotates forward, and after an elapse of a predetermined time after the timing roller 31 is driven, the inversion roller 44 stops. Thus, the inversion roller 44 holds the paper entering from the path switching gate 49 with a rear end of the paper having passed through the path switching gate 49. The inversion roller 44 performs the inversion operation after the waiting operation. When performing the inversion operation, the inversion roller 44 rotates in reverse and conveys the held paper to the path switching gate 49. Thus, the paper is conveyed to the second conveying path 47 by the inversion roller 44 and then led to the front and back inversion path 48 by the path switching gate 49. When performing the paper discharging operation, the inversion roller 44 rotates forward and discharges the paper to the paper discharge tray 39.

The front and back inversion path 48 is a path that connects the path switching gate 49 and the timing roller 31 in the image forming path 45 each other. The paper entering the front and back inversion path 48 from the path switching gate 49 is conveyed to the timing roller 31 by a conveying roller 38. Thus, an image is formed on a front surface of the paper while the paper initially passes through the image forming path 45, and an image is formed on a back surface of the paper while the paper passes through the image forming path 45 again via the front and back inversion path 48. The paper with the image formed on the back surface is led to the first conveying path 46 by the path switching gate 49 and is then discharged onto the paper discharge tray 39.

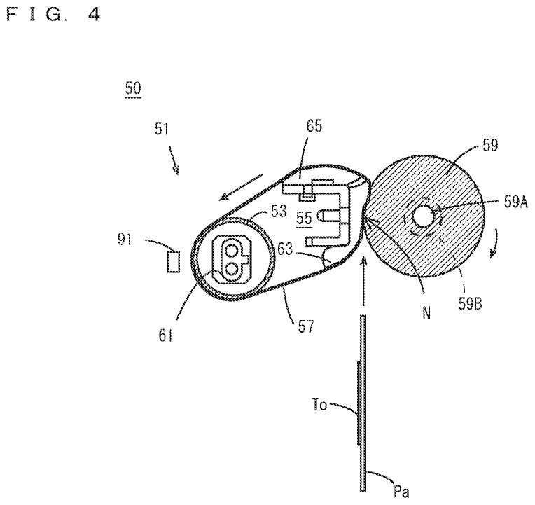

FIG. 4 is a cross sectional view of the fuser device. FIG. 4 shows a cross section of the fuser device 50 cut along a plane to which a rotation axis 59A of the pressure roller 59 forms a normal. With reference to FIG. 4, the fuser device 50 includes a heating unit 51 and the pressure roller 59. The heating unit 51 is provided to be opposite to the pressure roller 59, and a nip portion N is formed between the heating unit 51 and the pressure roller 59. The nip portion N is a portion at which the heating unit 51 and the pressure roller 59 come into contact with each other.

The pressure roller 59 is pressurized toward the heating unit 51 by a predetermined pressing force.

A paper Pa with a toner image To carried on a surface thereof is conveyed from a position downward of the fuser device 50 toward a position upward of the fuser device 50 and then passes through the nip portion N. While passing through the nip portion N, the paper Pa is heated and pressurized by the pressure roller 59 and the heating unit 51, so that the toner image To is fused on the paper Pa.

The pressure roller 59 is constituted by a cored bar, an intermediate layer, and a surface layer. In the present embodiment, the pressure roller 59 has an outer diameter of 30 mm. The cored bar is made of aluminum or iron and has a thickness of 2 to 3 mm. The intermediate layer is an elastic layer formed of a heat-resisting and elastic material such as silicone rubber or silicone sponge. The intermediate layer preferably has a thickness of 2 to 5 mm. The surface layer is formed of a material having mold releasability such as a fluorine tube, and the releasable surface layer preferably has a thickness of approximately 20 to 80 μm.

The heating unit 51 includes a heated roller 53, a pressure unit 55, an endless fuser belt 57, and a thermistor 91. The fuser belt 57 is a flexible endless belt. The fuser belt 57 is suspended by the heated roller 53 and the pressure unit 55 so as not to be loosened. The fuser belt 57 is constituted by a base layer and an elastic layer. The base layer is formed of a polyimide that has an inner diameter of 40 mm, a width of 340 mm, and a thickness of 70 μm. The elastic layer uses a silicone rubber and preferably has a thickness of approximately 100 to 150 μm. Also, the surface layer is coated with a releasable layer made of fluorine with a thickness of approximately 30 μm.

The heated roller 53 is driven to rotate in association with the rotation of the fuser belt 57. The fuser belt 57 may slide on a surface of the heated roller 53 such that the heated roller 53 does not rotate.

The pressure unit 55 has a pressing member 63 and a grease coating unit 65. The pressing member 63 is formed of a heat-resisting resin member and has a shape that has a length equal to or more than a maximum paper width to be subjected to a fusing process. The pressing member 63 is fixed to a main body frame. A portion of the pressing member 63 corresponding to the nip portion N has a shape that approximates a curvature of the pressure roller 59. Therefore, the area of the nip portion N can be as large as possible while the amount of elastic deformation of the pressure roller 59 is reduced. Since the area of the nip portion N can be larger, a period of time in which a paper is pressurized and heated can be longer. Also, since the outer diameter of the pressure roller 59 can be set to a predetermined value or less, the fuser device 50 can be reduced in size. Further, since the amount of elastic deformation of the pressure roller 59 can be reduced, a pressing force that pressurizes the pressure roller 59 can be reduced. As such, since the strength of the pressure roller 59 can be set to a predetermined value or less, heat capacity of the pressure roller 59 can be reduced by reducing the thickness of the pressure roller 59. Further, since the heat capacity of the pressure roller 59 can be reduced, power consumption is reduced.

A sliding sheet is fixed on the side of the nip portion N of the pressing member 63 to enhance slidability of a surface of the pressing member 63. The sliding sheet is made of a material in which a heat-resisting glass cloth is coated with fluorine resin, and has heat resistance, abrasion resistance, and slidability. The fuser belt 57 comes into contact with the sliding sheet. Therefore, an extent to which the fuser belt 57 is consumed due to friction can be made as small as possible.

The grease coating unit 65 accumulates grease as a lubricant and applies the grease on the fuser belt 57 by a portion that is in contact with the fuser belt 57. The grease is applied on an inner face of the fuser belt 57 by friction between the fuser belt 57 and the grease coating unit 65 while the fuser belt 57 passes through the grease coating unit 65. Thus, frictional resistance offered to the fuser belt 57 from the pressing member 63 is reduced and, therefore, a load received to rotate the fuser belt 57 around the heated roller 53 and the pressure unit 55 is reduced.

The heated roller 53 is a hollow cylindrical member and incorporates a heat source 61 therein. An inner diameter of the heated roller 53 is set to a size in which the heat source 61 does not come into contact with the heated roller 53. The heated roller 53 is made of stainless steel. Since the heated roller 53 is made of stainless steel, the heated roller 53 ensures its strength and is also easily processed. In this case, the thickness of the heated roller 53 can be around 0.1 mm to 0.2 mm. The heated roller 53 may be made of aluminum. In this case, the thickness of the heated roller 53 is preferably set to 0.25 mm or more in order to ensure the strength to bending or local deformation. Also, the heated roller 53 may be made of iron metal such as STKM (carbon steel tubes for machine structural purposes).

The heat source 61 is a halogen heater, for example. In the present embodiment, two halogen heaters with different light emission lengths are used as the heat source 61. The heat source 61 is not limited to the halogen heater, and a resistance heating element or IH (Induction Heating) may be used.

With the heat source 61 generating heat, the heated roller 53 is heated and the temperature of the heated roller 53 is increased. The temperature of the heated roller 53 is detected by the thermistor 91. In response to the temperature detected by the thermistor 91, the heat source 61 is controlled to be turned on/off, and the temperature of the heated roller 53 is controlled to reach a predetermined temperature. With the thickness of the heated roller 53 reduced, the heat capacity of the heated roller 53 is reduced. As such, since a rate of temperature increase of the heated roller 53 is increased, a warm-up time required for the temperature of the heated roller 53 to reach the predetermined temperature can be shortened. Also, power to be consumed by the heat source 61 can be reduced.

The fuser belt 57 is heated to a predetermined temperature by heat transmitted from the heated roller 53 while the fuser belt 57 is in contact with the heated roller 53.

The pressure roller 59 is rotated by a driving motor 59B. The fuser belt 57 is driven to rotate in association with the rotation of the pressure roller 59. The fuser belt 57 is heated by the heated roller 53 while being rotated. After the fuser belt 57 is heated to the predetermined temperature, the paper Pa, on which the toner image To is carried is controlled to enter the nip portion N. While the paper Pa passes through the nip portion N, the toner image To is fused on the paper Pa by heat and pressure.

While the heat of the heated roller 53 is transmitted by heat conduction to heat the fuser belt 57 by way of example in the present embodiment, the fuser belt 57 may be heated utilizing radiation heat emitted from the heated roller 53. In this case, the fuser belt 57 and the heated roller 53 do not need to come into contact with each other. Thus, the fuser belt 57 does not need to be suspended by the heated roller 53 and the pressure unit 55. Specifically, the fuser belt 57 is pressurized between the pressure unit 55 and the pressure roller 59 and is supported by the pressure unit 55 and the pressure roller 59. Also, the fuser belt 57 slides with respect to the pressing member 63 in association with the rotation of the pressure roller 59. Thus, the fuser belt 57 rotates around the pressure unit 55 and the heated roller 53.

Also, the heated roller 53 may be arranged outside of the fuser belt 57. In this case, the fuser belt 57 rotates around the pressure unit 55. Also, the heated roller 53 is not necessarily cylindrical and can use an induction heating device or a ceramic heater functioning as a heat source.

The printer 100 in the present embodiment includes a pressing force adjustment mechanism 70 that adjusts a pressing force with which the pressure roller 59 presses the heating unit 51.

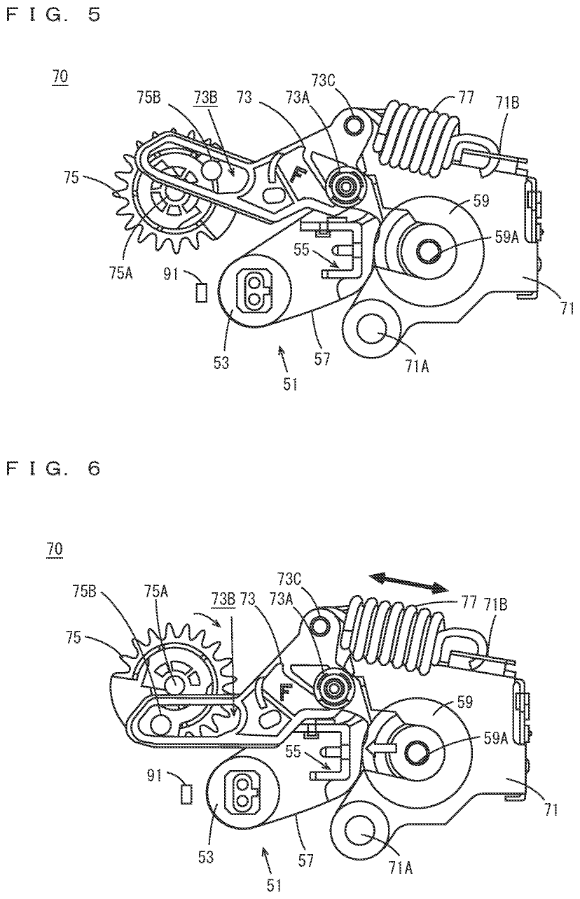

FIGS. 5 and 6 are diagrams showing the pressing force adjustment mechanism. With reference to FIGS. 5 and 6, the pressing force adjustment mechanism 70 includes a pressure frame 71, a lever member 73, a variable load gear 75, and a spring 77. The pressure unit 55 has its opposite ends fixedly supported to a main body frame.

The pressure frame 71 is rotatably supported about a pressure frame rotation axis 71A. The pressure frame rotation axis 71A is fixedly supported to the main body frame. The pressure frame 71 pivotally supports the rotation axis 59A of the pressure roller 59. As such, the rotation axis 59A of the pressure roller 59 is rotatable about the pressure frame rotation axis 71A. The pressure frame 71 has a first connection portion 71B connected to one end of the spring 77.

The lever member 73 is rotatably supported about a lever member rotation axis 73A. The lever member rotation axis 73A is fixedly supported to the main body frame. The lever member 73 has a second connection portion 73C connected to another end of the spring 77. The spring 77 biases in a direction of shortening a distance between the first connection portion 71B and the second connection portion 73C. As such, the pressure frame 71 is biased by the spring 77 in a counterclockwise direction about the pressure frame rotation axis 71A, and the lever member 73 is biased by the spring 77 in a clockwise direction about the lever member rotation axis 73A. Thus, the pressure roller 59 is pressed toward the heating unit 51.

The variable load gear 75 has a gear rotation axis 75A pivotally supported to the main body frame, and an adjustment rod 75B parallel to the gear rotation axis 75A. The variable load gear 75 is rotated about the gear rotation axis 75A by a driving motor.

An adjustment hole 73B through which the adjustment rod 75B of the variable load gear 75 passes is formed in the lever member 73. When the variable load gear 75 rotates in the clockwise direction, the adjustment rod 75B abuts against a side surface of the adjustment hole 73B and then slides. The lever member 73 is rotatably supported about the lever member rotation axis 73A. Thus, the other end of the spring 77 is pulled, so that a biasing force of the spring 77 is increased. As such, the pressing force that presses the pressure roller 59 toward the heating unit 51 is increased.

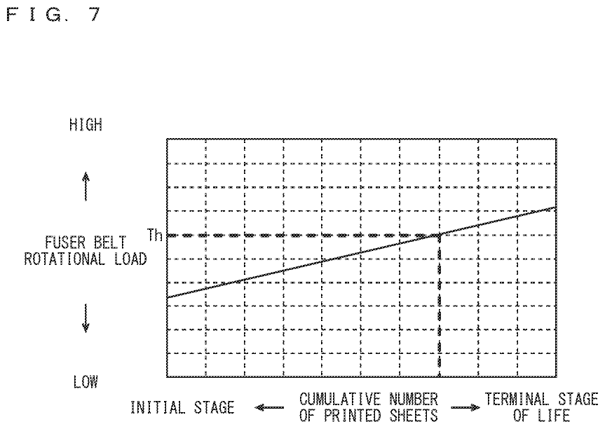

FIG. 7 is a diagram showing one example of a relationship between a cumulative number of printed sheets and a rotational load. The cumulative number of printed sheets is a cumulative value of the number of times at which papers pass through the fuser device 50 after the printer 100 is set. The rotational load is a load required to rotate the fuser belt 57. In the present embodiment, the rotational load of the fuser belt 57 is a torque of the driving motor 59B that rotates the pressure roller 59. With reference to FIG. 7, the rotational load of the fuser belt 57 is increased with an increase of the cumulative number of printed sheets. A predetermined load (rotational load) is generated when the fuser belt 57 is rotated around the heated roller 53 and the pressure unit 55. In particular, the rotational load is increased with an increase in the number of times of uses of the fuser device 50. For example, abrasion powder is gradually accumulated on an inner surface of the fuser belt 57, and thus sliding resistance between the inner surface of the fuser belt 57 and the pressing member 63 is increased, so that the rotational load is increased. Also, the grease is applied on the inner side of the fuser belt 57 by the grease coating unit 65; however, as the number of times of uses is increased, the grease is reduced. When the grease applied to the inner side of the fuser belt 57 is reduced, the sliding resistance between the inner side of the fuser belt 57 and the pressing member 63 is increased, so that the rotational load is increased.

A threshold value Th is a value that is predetermined as a rotational load in which slippage may be generated between the fuser belt 57 and the pressure roller 59. The threshold value Th is a value calculated by an experiment or simulation.

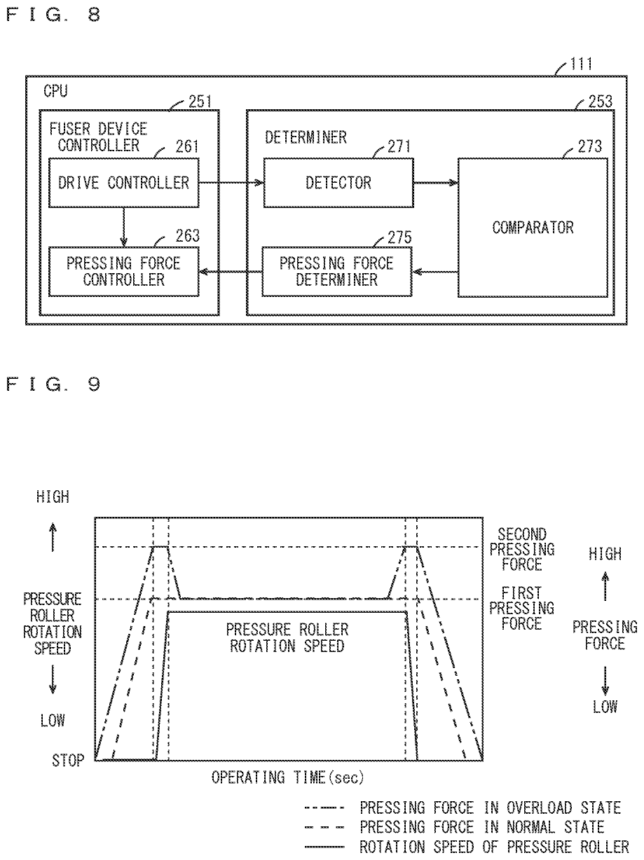

FIG. 8 is a block diagram showing one example of functions of the CPU included in the printer in the first embodiment. The functions shown in FIG. 8 are functions implemented by the CPU 111 included in the printer 100 that executes a pressing force control program stored in the ROM 113, the HDD 115 or the CD-ROM 118. With reference to FIG. 8, the CPU 111 included in the printer 100 includes a fuser device controller 251 that controls the fuser device 50, and a determiner 253 that determines a pressing force.

The fuser device controller 251 includes a drive controller 261 and a pressing force controller 263. The determiner 253 includes a detector 271, a comparator 273, and a pressing force determiner 275.

The drive controller 261 controls the driving motor 59B to drive the driving motor 59B. Specifically, the drive controller 261 drives the driving motor 59B such that a rotation speed of the pressure roller 59 is constant. In the present embodiment, the drive controller 261 controls a current of the driving motor 59B. The drive controller 261 outputs a value of the current flowing through the driving motor 59B to the detector 271.

The detector 271 detects a load of the fuser belt 57 based on the current flowing through the driving motor 59B that rotates the pressure roller 59. The load of the fuser belt 57 is a load required to rotate the fuser belt 57 at a constant speed, which is also referred to as a rotational load. The rotation speed of the pressure roller 59 is detected by an encoder. In a case where the fuser belt 57 and the pressure roller 59 do not slip, the load of the fuser belt 57 can be regarded as the same as a torque for rotating the pressure roller 59 at a constant speed. The detector 271 determines the torque for rotating the pressure roller 59 at the constant speed as the load of the fuser belt 57. The value of the current flowing through the driving motor 59B has a predetermined relationship with the torque for rotating the pressure roller 59 at the constant speed. The detector 271 detects the torque for rotating the pressure roller 59 at the constant speed from a current value input from the drive controller 261 using a relationship between a current value and a torque that is obtained in advance by an experiment or the like. The detector 271 outputs the torque for rotating the pressure roller 59 at the constant speed to the comparator 273.

The comparator 273 inputs the torque of the pressure roller 59 from the detector 271. The comparator 273 compares the torque of the pressure roller 59 with the threshold value Th to output a result of the comparison to the pressing force determiner 275. The threshold value Th is a value that is predetermined as a rotational load that may generate slippage between the fuser belt 57 and the pressure roller 59. The threshold value Th is a value calculated by an experiment or simulation. The comparator 273 outputs a result of the comparison indicating an overload state in a case where the rotational load of the fuser belt 57 is equal to or more than the threshold value Th. The comparator 273 outputs a result of the comparison indicating a normal state in a case where the rotational load of the fuser belt 57 is less than the threshold value Th.

The pressing force determiner 275 determines a pressing force based on the result of the comparison. The pressing force determiner 275 outputs the determined pressing force to the pressing force controller 263. Specifically, in a case where the result of the comparison indicates the normal state, the pressing force determiner 275 determines pressing forces during acceleration or deceleration and during rotation at a constant speed, respectively, to be first pressing forces. In a case where the result of the comparison indicates the overload state, the pressing force determiner 275 determines the pressing force during the acceleration or deceleration as a second pressing force and determines the pressing force during the rotation at the constant speed as the first pressing force. The second pressing force is larger than the first pressing force. The detector 271 detects the rotational load of the fuser belt 57 while a paper passes between the pressure roller 59 and the fuser belt 57. As such, the pressing force determiner 275 determines a pressing force corresponding to a paper subsequent to the paper that passes between the pressure roller 59 and the fuser belt 57. The detector 271 may detect the rotational load of the fuser belt 57 while no paper passes between the pressure roller 59 and the fuser belt 57.

The pressing force controller 263 controls the pressing force adjustment mechanism 70 to adjust the pressing force with which the pressure roller 59 presses the pressing member 63. The pressing force controller 263 inputs the rotation speed of the pressure roller 59 from the drive controller 261 and inputs the pressing force from the pressing force determiner 275. The pressing force controller 263 rotates the variable load gear 75 such that the pressing force, with which the pressure roller 59 presses the fuser belt 57 attains a same value as that of the pressing force input from the pressing force determiner 275 each of during the acceleration or deceleration and during the rotation at the constant speed of the pressure roller 59. A predetermined time is required to rotate the variable load gear 75 to adjust the pressing force. As such, the pressing force controller 263 rotates the variable load gear 75 by a predetermined time before the time at which the pressure roller 59 is accelerated or decelerated. In a case where the pressing force is instantaneously changeable using an elastic member such as a spring without using the variable load gear 75, the pressing force controller 263 may change the pressing force at the same time as the pressure roller 59 is accelerated or decelerated.

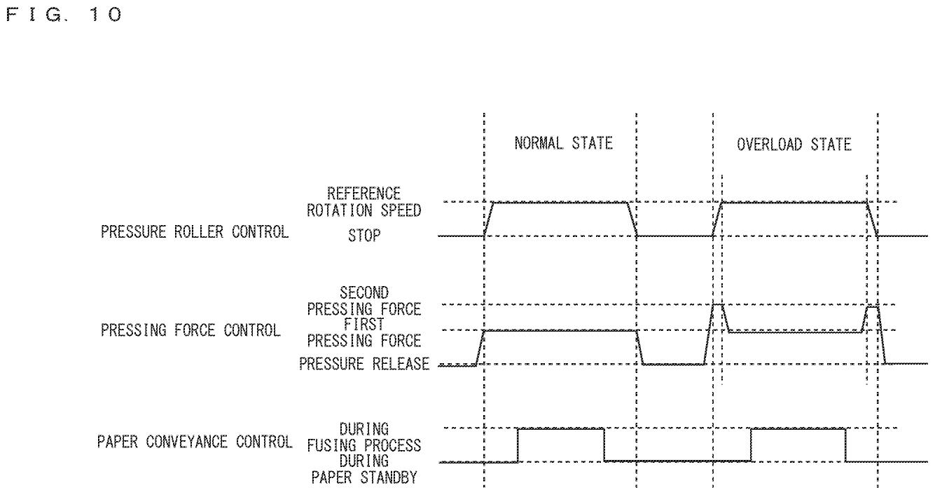

FIG. 9 is a diagram showing one example of a relationship between the rotation speed and the pressing force of the pressure roller in the first present embodiment. The abscissa indicates an elapse of time, and the rotation speed of the pressure roller 59 is denoted by the solid line. The pressing force in the normal state is denoted by the dotted line, and the pressing force in the overload state is denoted by the one-dot and dash line. The rotation speed of the pressure roller 59 accelerates to a predetermined rotation speed, becomes a constant speed for a predetermined time, and decelerates until the pressure roller 59 stops.

The pressing force in the normal state increases to a first pressing force before the pressure roller 59 accelerates. A point in time at which the pressing force starts increasing is a point in time that is before a point in time at which the pressure roller 59 accelerates by a period of time required to increase the pressing force to the first pressing force by rotating the variable load gear 75. Then, the pressing force is maintained during a period in which the pressure roller 59 accelerates, rotates at the constant speed, decelerates, and stops. Further, the pressing force decreases when the pressure roller 59 stops. Thus, the pressure roller 59 is spaced apart from the fuser belt 57 and, therefore, deterioration due to deformation or the like of the pressure roller 59 is prevented.

The pressing force in the overload state increases to a second pressing force before the pressure roller 59 accelerates. A point in time at which the pressing force starts increasing is a point in time that is before a point in time at which the pressure roller 59 accelerates by a period of time required to increase the pressing force to the second pressing force by rotating the variable load gear 75. Then, the pressing force decreases to the first pressing force at a point in time at which the pressure roller 59 rotates at the constant speed after the acceleration. Then, the pressing force increases to the second pressing force before the pressure roller 59 decelerates. A point in time at which the pressing force starts increasing is a point in time that is before a point in time at which the pressure roller 59 decelerates by a period of time required to increase the pressing force from the first pressing force to the second pressing force by rotating the variable load gear 75. Then, the second pressing force is maintained during a period in which the pressure roller 59 decelerates and stops. Further, the pressing force decreases from the second pressing force when the pressure roller 59 stops. Thus, the pressure roller 59 is spaced apart from the fuser belt 57 and, therefore, deterioration due to deformation or the like of the pressure roller 59 is prevented.

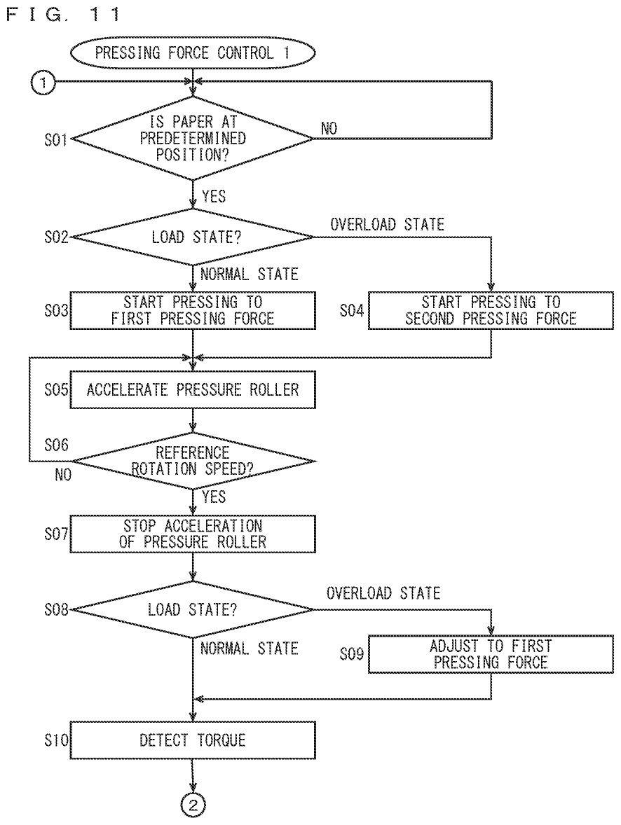

FIG. 10 is a diagram showing one example of a temporal relationship among pressure roller control, the pressing force, and a position of a paper in the first embodiment. With reference to FIG. 10, in the normal state, the pressing force, with which the pressure roller 59 is pressed to the fuser belt 57 increases to the first pressing force before the pressure roller 59 starts rotating. With the pressing force being the first pressing force, the pressure roller 59 accelerates and rotates at a reference rotation speed. A paper passes through the nip portion N between the pressure roller 59 and the fuser belt 57 while the pressure roller 59 rotates at the reference rotation speed. In FIG. 10, a state where the paper is passing through the nip portion N is indicated as “during fusing process”, and a state where the paper is not passing through the nip portion N is indicated as “during paper standby.” After the paper passes through the nip portion N, the pressure roller 59 decelerates. After the pressure roller 59 stops, the pressing force decreases from the first pressing force, and the pressing force is released to zero.

In the overload state, the pressing force, with which the pressure roller 59 is pressed to the fuser belt 57 increases to the second pressing force before the pressure roller 59 starts rotating. With the pressing force being the second pressing force, the pressure roller 59 accelerates and rotates at the reference rotation speed. When the pressure roller 59 reaches the reference rotation speed, the pressing force decreases from the second pressing force to the first pressing force. Then, the paper passes through the nip portion N between the pressure roller 59 and the fuser belt 57 while the pressing force is the first pressing force and the pressure roller 59 rotates at the reference rotation speed. After the paper passes through the nip portion N and before the pressure roller 59 decelerates, the pressing force, with which the pressure roller 59 is pressed to the fuser belt 57 increases from the first pressing force to the second pressing force. With the pressing force being the second pressing force, the pressure roller 59 decelerates and stops. After the pressure roller 59 stops, the pressing force decreases from the second pressing force, and the pressing force is released to zero.

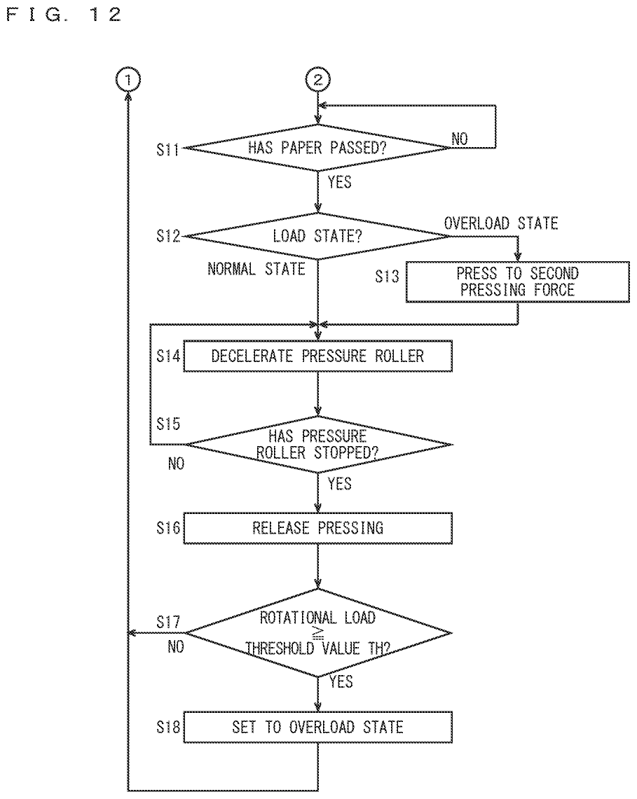

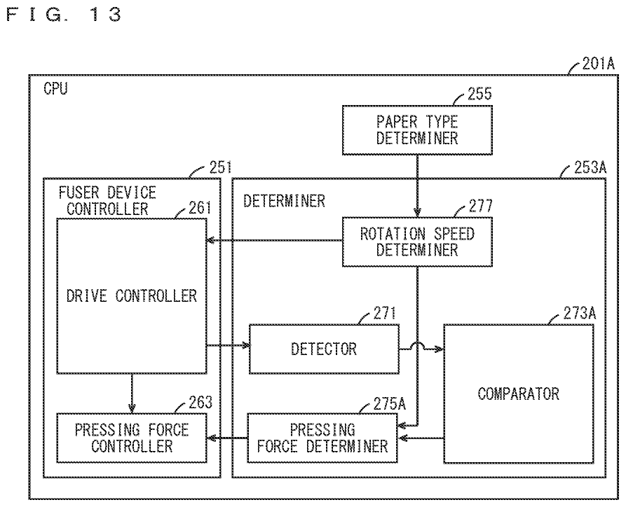

FIGS. 11 and 12 are flowcharts showing one example of a flow of a pressing force control process in the first embodiment. The pressing force control process is a process executed by the CPU 111 that executes a pressing force control program stored in the ROM 113, the HDD 115 or the CD-ROM 118 included in the printer 100. With reference to FIGS. 11 and 12, the CPU 111 included in the printer 100 determines whether a paper arrives at a predetermined position (step S01). The CPU 111 waits until the paper arrives at the predetermined position (NO in step S01). If the paper arrives at the predetermined position (YES in step S01), the process proceeds to step S02. The predetermined position is defined to be a position upstream of the conveying path on the basis of the fuser device 50. For example, the predetermined position may be a position at which the second transfer roller 26 is arranged.

In step S02, the process is branched depending on a load state. The load state is a state of the rotational load of the fuser belt 57 and includes a normal state and an overload state. The load state is set to the normal state by default and set to the overload state in step S18 which will be described below. If the load state is the normal state, the process proceeds to step S03. If the load state is the overload state, the process proceeds to step SO4.

In step S03, adjustment of the pressing force is started until the pressing force reaches the first processing force. The CPU 111 rotates the variable load gear 75 to increase the pressing force to the first pressing force. Then in step S05, the pressure roller 59 is accelerated. In step S03, a point in time at which the rotation of the variable load gear 75 is started is adjusted to a point in time that is before a point in time at which the pressure roller 59 accelerates from the stop state by a period of time required to increase the pressing force to the first pressing force by rotating the variable load gear 75.

In step SO4, the adjustment of the pressing force is started until the pressing force reaches the second pressing force. The CPU 111 rotates the variable load gear 75 to increase the pressing force to the second pressing force. Then in step S05, the pressure roller 59 is accelerated. In step SO4, a point in time at which the rotation of the variable load gear 75 is started is adjusted to a point in time that is before a point in time at which the pressure roller 59 accelerates from the stop state by a period of time required to increase the pressing force to the second pressing force by rotating the variable load gear 75. Thus, the pressing force can be the second pressing force while the pressure roller 59 is accelerating. In the overload state, the rotational load of the fuser belt 57 is equal to or more than the threshold value Th. Since the pressing force is the second pressing force higher than the first pressing force, a frictional force between the pressure roller 59 and the fuser belt 57 becomes larger. Thus, in a case where the rotational load of the fuser belt 57 is equal to or more than the threshold value Th, it is possible to make the fuser belt 57 and the pressure roller 59 slide as little as possible.

In step S06, it is determined whether the rotation speed of the pressure roller 59 is the reference rotation speed. The reference rotation speed is defined corresponding to a speed at which the paper passes through the fuser device 50. If the pressure roller 59 accelerated in step S05 rotates at the reference rotation speed, the process proceeds to step S07. If not, the process returns to step S05.

In step S07, the acceleration of the pressure roller 59 is stopped. Thus, the pressure roller 59 rotates at the constant speed. In step S08, the process is branched depending on the load state. If the load state is the normal state, the process proceeds to step S10. If the load state is the overload state, the process proceeds to step S09. In step S09, the pressing force is adjusted to the first processing force, and the process proceeds to step S10. The CPU 111 rotates the variable load gear 75 to reduce the pressing force from the second pressing force to the first pressing force.

In step S10, a torque of the driving motor 59B is detected, and the process proceeds to step S11. In step S11, it is determined whether the paper has passed through. The CPU 111 waits until the paper passes through the fuser device 50 (NO in step S11). If the paper has passed through (YES in step S11), the process proceeds to step S12.

In step S12, the process is branched depending on the load state. If the load state is the normal state, the process proceeds to step S14. If the load state is the overload state, the process proceeds to step S13. In step S14, the pressure roller 59 decelerates, and the process proceeds to step S15.

In step S13, the adjustment of the pressing force is started until the pressing force reaches the second pressing force. The CPU 111 rotates the variable load gear 75 to increase the pressing force from the first pressing force to the second pressing force. Then in step S14, the pressure roller 59 is decelerated. In step S13, a point in time at which the rotation of the variable load gear 75 is started is adjusted to a point in time that is before a point in time at which the pressure roller 59 decelerates by a period of time required to increase the pressing force from the first pressing force to the second pressing force by rotating the variable load gear 75. Thus, the pressing force can be the second pressing force while the pressure roller 59 is decelerating. In the overload state, the rotational load of the fuser belt 57 is equal to or more than the threshold value Th. Since the pressing force is increased to the second pressing force higher than the first pressing force, the frictional force between the pressure roller 59 and the fuser belt 57 becomes larger. Thus, in a case where the rotational load of the fuser belt 57 is equal to or more than the threshold value Th, it is possible to make the fuser belt 57 and the pressure roller 59 slide as little as possible.

In step S15, it is determined whether the pressure roller 59 has stopped. If the pressure roller 59 has stopped, the process proceeds to step S16. If not, the process returns to step S14. The pressing force is released in step S16, and the process proceeds to step S17. The CPU 111 rotates the variable load gear 75 to reduce the pressing force to zero.

In step S17, it is determined whether the rotational load is equal to or more than the threshold value Th. The rotational load of the fuser belt 57 is calculated based on the torque of the driving motor 59B detected in step S10. If the rotational load is equal to or more than the threshold value Th, the process proceeds to step S18. If not, the process returns to step S01. The load state is set to the overload state in step S18, and the process returns to step S01.

As has been described above, the printer 100 in the first embodiment functions as the image forming apparatus. This printer 100 includes the pressure roller 59, the driving motor 59B that drives the rotation of the pressure roller 59, the endless fuser belt 57, the pressing member 63 that forms the nip portion N where the fuser belt 57 and the pressure roller 59 come into contact with each other, the pressing force adjustment mechanism 70 that adjusts the pressing force that presses one of the pressure roller 59 and the pressing member 63 to the other, the detector 271 that detects the rotational load of the fuser belt 57, and the pressing force controller 263 that controls the pressing force adjustment mechanism 70. The pressing force controller 263 controls the pressing force adjustment mechanism 70 such that, in the case of the overload state where the rotational load of the fuser belt 57 detected by the detector 271 is equal to or more than the threshold value Th, the pressing force reaches the second pressing force higher than the first pressing force in the normal state where the rotational load of the fuser belt 57 detected by the detector 271 is less than the threshold value Th. As such, the fuser belt 57 comes into contact with the pressure roller 59 between the pressure roller 59 and the pressing member 63 and rotates outside of the pressing member 63 by the frictional force received from the pressure roller 59. The pressing force adjustment mechanism 70 is controlled such that the pressing force in the overload state where the rotational load of the fuser belt 57 is equal to or more than the threshold value Th reaches the second pressing force higher than the first pressing force in the normal state where the rotational load of the fuser belt 57 is less than the threshold value Th. As such, the frictional force generated on a contact surface between the pressure roller 59 and the fuser belt 57 is adjusted in response to a time-dependent change in the rotational load of the fuser belt 57 and, therefore, the frequency of stick-slip of the fuser belt 57 and the pressure roller 59 can be reduced. As a result, generation of abnormal noises from the fuser device 50 can be reduced.

Also, the printer 100 adjusts the pressing force such that it reaches the second pressing force higher than the first pressing force in the normal state while the pressure roller 59 is accelerating or decelerating. As such, since the pressing force becomes higher in the overload state than in the normal state while the pressure roller 59 is accelerating or decelerating, the frictional force between the fuser belt 57 and the pressure roller 59 becomes higher while the pressure roller 59 is accelerating or decelerating. Since the stick-slip is likely to occur while the pressure roller 59 is accelerating or decelerating, generation of the abnormal noises due to the stick-slip while the pressure roller 59 is accelerating or decelerating can be reduced.

Also, the printer 100 causes the pressing force adjustment mechanism 70 to start adjusting the pressing force before the pressure roller 59 accelerates or at the same time as the pressure roller 59 accelerates. Therefore, the pressing force can be the second pressing force higher than the first pressing force in the normal state while the pressure roller 59 is accelerating.

Also, the printer 100 causes the pressing force adjustment mechanism 70 to start adjusting the pressing force before the pressure roller 59 starts decelerating or at the same time as the pressure roller 59 starts decelerating. Therefore, the pressing force can be the second pressing force higher than the first pressing force in the normal state while the pressure roller 59 is decelerating.

Also, the printer 100 causes the pressing force adjustment mechanism 70 to continue the state of the second pressing force higher than the first pressing force in the normal state for a predetermined time. Therefore, the pressing force can be higher than that in the normal state during a period in which the stick-slip is more likely to occur. Further, since the period in which the pressing force is the second pressing force higher than the first pressing force in the normal state is limited, the life of the pressure roller 59 can be increased by reducing the load of the pressure roller 59 as low as possible.

Also, the detector 271 detects the rotational load of the fuser belt 57 based on a rotation torque of the driving motor 59B that drives the pressure roller 59. As such, the rotational load of the fuser belt 57 can be easily detected.

Also, the detector 271 detects the rotational load of the fuser belt 57 based on a cumulative number of rotations of the pressure roller 59. As such, the rotational load of the fuser belt 57 can be easily detected.

Also, the detector 271 detects the rotational load of the fuser belt 57 based on a cumulative number of sheets of a recording medium passing through the nip portion N. As such, the rotational load of the fuser belt 57 can be easily detected.

### Second Embodiment

The printer 100 in the first embodiment increases the pressing force to the second pressing force while the pressure roller 59 accelerates or decelerates in the case where the load state is the overload state. The printer 100 in the second embodiment increases the pressing force to the second pressing force also while the pressure roller 59 rotates at the constant speed as well as while the pressure roller 59 accelerates or decelerates in the case where the load state is the overload state. The printer 100 in the second embodiment will now be described with respect to points that are different from those of the printer 100 in the first embodiment.

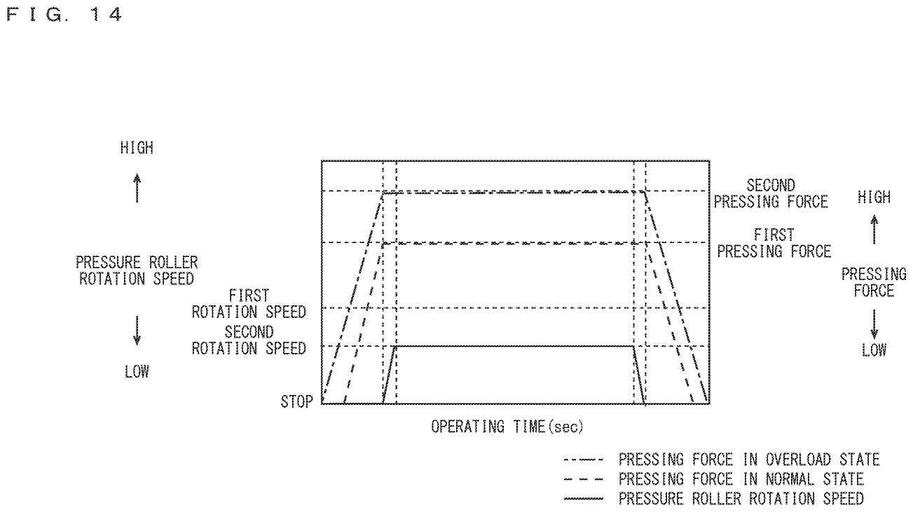

FIG. 13 is a block diagram showing one example of functions of the CPU included in the printer in the second embodiment. With reference to FIG. 13, the functions shown in FIG. 13 different from those shown in FIG. 8 are that a paper type determiner 255 is added and that the determiner 253 is replaced by a determiner 253A. The remaining functions in FIG. 13 are the same as those shown in FIG. 8 and are therefore not described again.

With reference to FIG. 13, the paper type determiner 255 determines a type of a recording medium as a target for image formation performed by the printer 100 and outputs the type of the recording medium to the determiner 253A. The type of the recording medium accommodated in each of the paper feed cassette 35 and the manual feed cassette 35A is set by the user in advance. The paper type determiner 255 may determine a type of a paper based on an output of a sensor arranged on the image forming path 45. The sensor is arranged at a position farther upstream than the fuser device 50 of the image forming path 45. The sensor is a transmissive sensor, and an ultrasonic sensor or a photoelectric sensor, for example, is used. A basis weight of a paper is detected based on an attenuation rate of an ultrasonic wave output from the ultrasonic sensor or an attenuation rate of light output from the photoelectric sensor, so that the type of the paper corresponding to the basis weight is determined. The types of the paper include a plain paper, a cardboard, an envelope, etc.

The determiner 253A includes a rotation speed determiner 277, a detector 271, a comparator 273, and a pressing force determiner 275A. The rotation speed determiner 277 inputs the type of the recording medium from the paper type determiner 255. The rotation speed determiner 277 determines the rotation speed of the pressure roller 59 based on the type of the recording medium. The cardboard and the envelope are thicker than the plain paper. Therefore, the cardboard and the envelope are less likely to transmit heat than the plain paper when passing through the fuser device 50. The rotation speed determiner 277 sets the rotation speed of the pressure roller 59 to be a lower speed in the case of the thick recording medium than in the case of the thin recording medium. In the present embodiment, the rotation speed determiner 277 determines the rotation speed of the pressure roller 59 to be a first rotation speed in the case where the type of the paper is a plain paper, whereas the rotation speed determiner 277 determines the rotation speed of the pressure roller 59 to be a second rotation speed lower than the first rotation speed in the case where the type of the paper is a cardboard or an envelope. The rotation speed determiner 277 outputs the determined rotation speed to the drive controller 261 and the pressing force determiner 275A.

The pressing force determiner 275A inputs a result of comparison from the comparator 273A and inputs the rotation speed from the rotation speed determiner 277. The pressing force determiner 275A determines a pressing force based on the result of the comparison and the rotation speed. The pressing force determiner 275A outputs the determined pressing force to the pressing force controller 263. Specifically, in a case where the result of the comparison indicates the normal state, the pressing force determiner 275A determines respective pressing forces during acceleration or deceleration and during rotation at a constant speed to be first pressing forces regardless of the rotation speed. In a case where the result of the comparison indicates the overload state and the rotation speed indicates the first rotation speed, the pressing force determiner 275A determines the pressing force during the acceleration or deceleration to be a second pressing force and determines the pressing force during the rotation at the constant speed to be the first pressing force. In a case where the result of the comparison indicates the overload state and the rotation speed indicates the second rotation speed, the pressing force determiner 275A determines the respective pressing forces during the acceleration or deceleration and during the rotation at the constant speed to be second pressing forces. The second pressing force is larger than the first pressing force. The detector 271 detects the rotational load of the fuser belt 57 while a paper passes between the pressure roller 59 and the fuser belt 57. As such, the pressing force determiner 275A determines a pressing force corresponding to a paper subsequent to the paper that passes between the pressure roller 59 and the fuser belt 57.

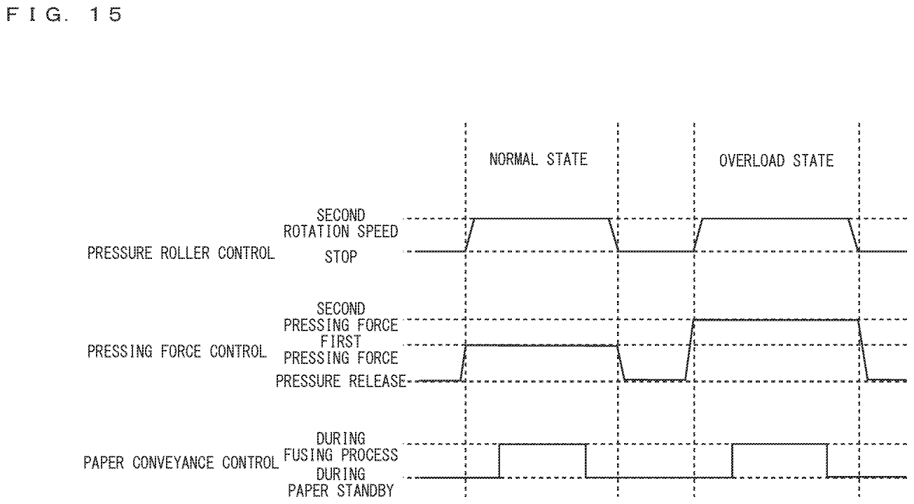

FIG. 14 is a diagram showing one example of a relationship between the rotation speed and the pressing force of the pressure roller in the second embodiment. The abscissa indicates an elapse of time, and the rotation speed of the pressure roller 59 is denoted by the solid line. FIG. 14 shows a relationship in a case where the type of paper is a cardboard or an envelope. The relationship in a case where the type of paper is a plain paper is the same as that shown in FIG. 7. The pressing force in the normal state is denoted by the dotted line, and the pressing force in the overload state is denoted by the one-dot and dash line. The rotation speed of the pressure roller 59 accelerates to the second rotation speed, becomes the constant speed for a predetermined time, and decelerates until the pressure roller 59 stops.

The pressing force in the normal state increases to the first pressing force before the pressure roller 59 accelerates. A point in time at which the pressing force starts increasing is a point in time that is before a point in time at which the pressure roller 59 accelerates by a period of time required to increase the pressing force to the first pressing force by rotating the variable load gear 75. Then, the pressing force is maintained during a period in which the pressure roller 59 accelerates, rotates at the constant speed, decelerates, and stops. Further, the pressing force decreases when the pressure roller 59 stops. Thus, the pressure roller 59 is spaced apart from the fuser belt 57 and, therefore, deterioration due to deformation or the like of the pressure roller 59 is prevented.

The pressing force in the overload state increases to the second pressing force before the pressure roller 59 accelerates. A point in time at which the pressing force starts increasing is a point in time that is before a point in time at which the pressure roller 59 accelerates by a period of time required to increase the pressing force to the second pressing force by rotating the variable load gear 75. Then, the pressing force is maintained at the second pressing force during a period in which the pressure roller 59 accelerates, rotates at the constant speed, decelerates, and stops. Further, the pressing force decreases when the pressure roller 59 stops. Thus, the pressure roller 59 is spaced apart from the fuser belt 57 and, therefore, deterioration due to deformation or the like of the pressure roller 59 is prevented.

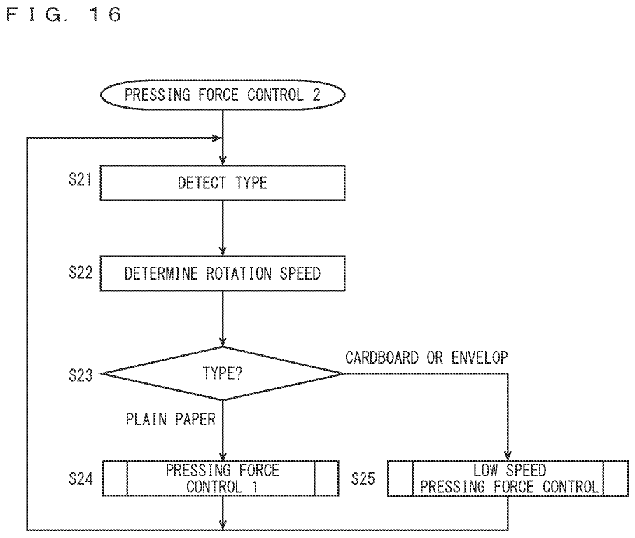

FIG. 15 is a diagram showing one example of a temporal relationship among the pressure roller control, the pressing force, and the position of a paper in the second embodiment. Pressing force control and pressure roller control each indicates control in the case where the type of paper is a cardboard or an envelope. With reference to FIG. 15, in the normal state, the pressing force with which the pressure roller 59 is pressed to the fuser belt 57 increases to the first pressing force before the pressure roller 59 starts rotating. With the pressing force being the first pressing force, the pressure roller 59 accelerates and rotates at the second rotation speed. A paper passes through the nip portion N between the pressure roller 59 and the fuser belt 57 while the pressure roller 59 rotates at the second rotation speed. In FIG. 15, the state where the paper is passing through the nip portion N is indicated as “during fusing process,” and the state where the paper is not passing through the nip portion N is indicated as “during paper standby.” After the paper passes through the nip portion N, the pressure roller 59 decelerates. After the pressure roller 59 stops, the pressing force decreases from the first pressing force, and the pressing force is released to zero.

In the overload state, the pressing force, with which the pressure roller 59 is pressed to the fuser belt 57 increases to the second pressing force before the pressure roller 59 starts rotating. With the pressing force being the second pressing force, the pressure roller 59 accelerates and rotates at the second rotation speed. A paper passes through the nip portion N between the pressure roller 59 and the fuser belt 57 while the pressure roller 59 rotates at the second rotation speed. In FIG. 15, the state where the paper is passing through the nip portion N is indicated as “during fusing process,” and the state where the paper is not passing through the nip portion N is indicated as “during paper standby.” After the paper passes through the nip portion N, the pressure roller 59 decelerates. After the pressure roller 59 stops, the pressing force decreases from the second pressing force, and the pressing force is released to zero.

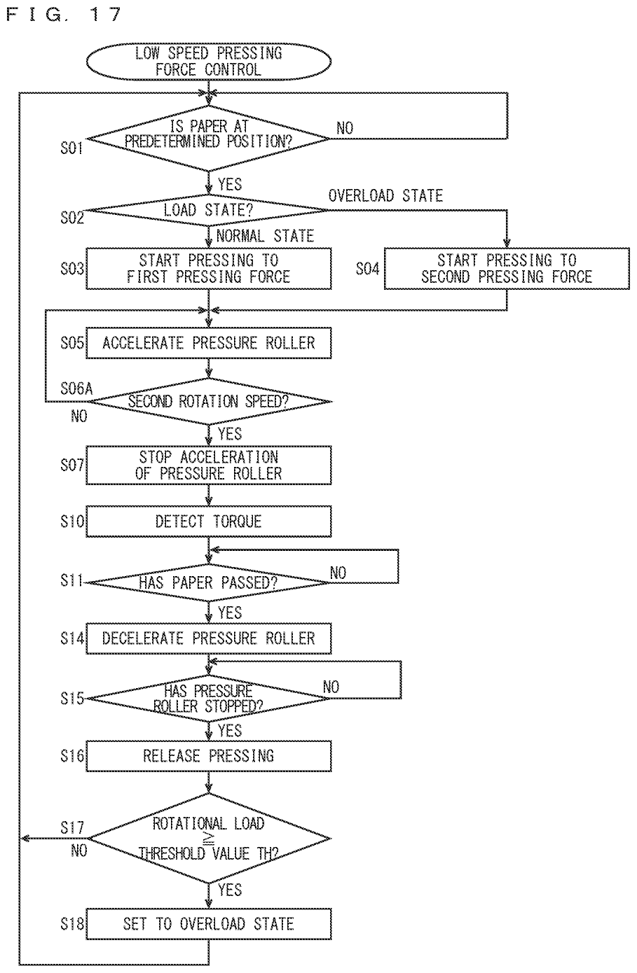

FIG. 16 is a flowchart showing one example of a flow of a pressing force control process in the second embodiment. The pressing force control process in the second embodiment is a process executed by the CPU 111 included in the printer 100 that executes a pressing force control program stored in the ROM 113, the HDD 115 or the CD-ROM 118. With reference to FIG. 16, the CPU 111 included in the printer 100 detects a type (step S21) and proceeds the process to step S22. The type of a recording medium to be subjected to the fusing process by the fuser device 50 is detected.

In step S22, the rotation speed of the pressure roller 59 is determined, and the process proceeds to step S23. The rotation speed is determined based on the type of the recording medium determined in step S21. If the type of the recording medium is a plain paper, the first rotation speed is determined, whereas if the type of the recording medium is a cardboard or an envelope, the second rotation speed is determined. The second rotation speed is lower than the first rotation speed.

In step S23, the process branches depending on the type of the recording medium. If the type of the recording medium is a plain paper, the process proceeds to step S24. If the type of the recording medium is a cardboard or an envelope, the process proceeds to step S25. In step S24, the pressing force control process in the first embodiment shown in FIG. 11 is executed, and the process returns to step S21. In step S25, a low speed pressing force control process is executed, and the process returns to step S21.

FIG. 17 is a flowchart showing one example of a flow of the low speed pressing force control process. In

FIG. 17, the same processes as those shown in FIG. 11 are denoted with the same signs. Processes different from those shown in FIG. 11 will now be described. With reference to FIG. 17, when the pressure roller 59 is accelerated in step S05, it is determined whether the rotation speed of the pressure roller 59 is the second rotation speed in subsequent step S06A. If the rotation speed of the pressure roller 59 is the second rotation speed, the process proceeds to step S07. If not, the process returns to step S05.

In step S07, the acceleration of the pressure roller 59 is stopped, and the process proceeds to step S10. The pressure roller 59 is put into a state of constant speed rotation at the second rotation speed.

A torque of the driving motor 59B is detected in step S10, and it is determined whether the paper has passed through in subsequent step S11. The CPU 111 waits until the paper passes through the fuser device 50 (NO in step S11). If the paper has passed through (YES in step S11), the process proceeds to step S14. In step S14, the pressure roller 59 decelerates, and the process proceeds to step S15.

In the printer 100 in the second embodiment, in the case where the type of the recording medium is a cardboard or an envelope, the pressing force adjustment mechanism 70 adjusts the pressing force such that it reaches the second pressing force higher than the first pressing force in the normal state while the pressure roller 59 passes through the nip portion N as well as while the pressure roller 59 accelerates or decelerates. As such, since the pressing force becomes the second pressing force higher than the first pressing force in the normal state while the cardboard or the envelope passes through the nip portion, the frictional force between the fuser belt 57 and the pressure roller 59 becomes higher while the cardboard or the envelope passes through the nip portion N. The rotational load of the fuser belt 57 becomes higher in the case of the lower rotation speed of the pressure roller 59 than in the case of the higher rotation speed of the pressure roller 59. Therefore, in the case where the rotation speed of the pressure roller 59 is lower as the recording medium is thicker, generation of abnormal noises due to a stick-slip in the case of the thick recording medium can be reduced.

### FIRST MODIFIED EXAMPLE

In a first modified example, the first pressing force varies depending on the size of a paper. In this case, the second pressing force is set to be larger than the first pressing force that is defined depending on the size of the paper. The size of the paper here refers to the length of the paper in a direction orthogonal to a direction in which the paper is conveyed. In other words, the size of the paper here refers to the length of the paper in a direction intersecting with a direction in which the paper passes through the nip portion N. The friction force between the fuser belt 57 and the pressure roller 59 has a predetermined relationship between an area in which the fuser belt 57 and the pressure roller 59 are in contact with each other and a pressing force with which the pressure roller 59 presses the fuser belt 57. The friction force becomes higher as the area becomes larger, and the friction force becomes higher as the pressing force becomes larger. The area in which the fuser belt 57 and the pressure roller 59 are in contact with each other becomes smaller when the paper passes through the nip portion N. Therefore, the fuser device 50 in the first modified example adjusts the first pressing force with which the pressure roller 59 presses the fuser belt 57 depending on the size of the paper. Specifically, the first pressing force, with which the pressure roller 59 presses the fuser belt 57 is increased as the size of the paper is increased.

### SECOND MODIFIED EXAMPLE

While the pressure roller 59 is pressed to the heating unit 51 in the present embodiment, the heating unit 51 may be pressed to the pressure roller 59.

### THIRD MODIFIED EXAMPLE

While the rotational load of the fuser belt 57 is calculated from the torque of the driving motor 59B that drives the pressure roller 59 in the present embodiment, the rotational load of the fuser belt 57 may be calculated from the number of times in which the fuser device 50 is driven or a rotation distance of the fuser device 50. Therefore, the load of the fuser belt 57 can be calculated from the number of times, in which the fuser device 50 is driven by calculating a relationship between the rotational load of the fuser belt 57 and the number of times, in which the fuser device 50 is driven by an experiment, simulation or the like. The number of times, in which the fuser device 50 is driven may use a cumulative value of the number of rotations of the pressure roller 59 or may use a cumulative value of the number of rotations of the fuser belt 57. While the comparator 273 compares the rotational load of the fuser belt 57 with the threshold value, the comparator 273 may compare the number of times, in which the fuser device 50 is driven with the threshold value. The threshold value in this case is determined by predetermining a relationship between the number of times, in which the fuser device 50 is driven, and the pressing force.

Also, as shown in FIG. 7, the rotational load of the fuser belt 57 is proportional to the cumulative number of printed sheets. As such, the rotational load of the fuser belt 57 may be calculated from the cumulative number of printed sheets. The load of the fuser belt 57 can be calculated from the cumulative number of printed sheets by calculating the relationship between the rotational load of the fuser belt 57 and the cumulative number of printed sheets by an experiment, simulation or the like.

While the example in which the pressure roller 59 is pressed to the fuser belt 57 is shown in the present embodiment, the pressure roller 59 may be spaced apart from the fuser belt 57 while the fuser device 50 is not driven. Preferably, the pressure roller 59 is pressed to the heating unit 51 at least while the paper passes through the nip portion N. Thus, a period in which the pressure roller 59 is elastically deformed can be limited to a period in which the recording medium passes through.

While the description is made on the printer 100 as the one example of the image forming apparatus in the present embodiment, the image forming apparatus may be a copying machine, a laser beam printer, a facsimile device, a Multi Function Peripheral that is a combination of these devices, etc.

While the printer 100 that forms a tandem type color image has been described as the one example of the image forming apparatus in the present embodiment, the image forming apparatus is not limited to this and may be an image forming apparatus that forms a monochrome image. The configurations or arrangements of the image forming units 20Y, 20M, 20C, 20K, the exposure devices 21Y, 21M, 21C, 21K, the charging rollers 22Y, 22M, 22C, 22K, the photoreceptor drums 23Y, 23M, 23C, 23K, the developers 24Y, 24M, 24C, 24K, the first transfer rollers 25Y, 25M, 25C, 25K, the second transfer roller 26, and the fuser device 50 are not limited to those of the present embodiments and may be other configurations or arrangements.

Although the embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus comprising:
a pressure roller;
a driving unit that drives rotation of the pressure roller;
an endless fuser belt;
a pressing member that is provided inside of the endless fuser belt to be opposite to the pressure roller and forms a nip portion where the fuser belt and the pressure roller come into contact with each other;
a pressing force adjustment mechanism that adjusts a pressing force that presses one of the pressure roller and the pressing member to the other;
a detector that detects a rotational load of the fuser belt; and
a pressing force controller that controls the pressing force adjustment mechanism such that the pressing force is higher in an overload state where the rotational load of the fuser belt detected by the detector is equal to or more than a predetermined value than in a normal state where the rotational load of the fuser belt is less than the predetermined value.

2. The image forming apparatus according to claim 1, wherein the pressing force controller controls the pressing force adjustment mechanism such that the pressing force while the pressure roller accelerates or decelerates is higher than the pressing force in the normal state.

3. The image forming apparatus according to claim 1, wherein the pressing force controller controls the pressing force adjustment mechanism such that the pressing force while a recording medium passes through the nip portion is higher than the pressing force in the normal state.

4. The image forming apparatus according to claim 1, wherein the pressing force controller causes the pressing force adjustment mechanism to start adjusting the pressing force before the pressure roller starts accelerating or at a same time as the pressure roller starts accelerating.

5. The image forming apparatus according to claim 1, wherein the pressing force controller causes the pressing force adjustment mechanism to start adjusting the pressing force before the pressure roller starts decelerating or at a same time as the pressure roller starts decelerating.

6. The image forming apparatus according to claim 1, wherein the pressing force controller causes the pressing force adjustment mechanism to continue the pressing force higher than the pressing force in the normal state for a predetermined time.

7. The image forming apparatus according to claim 1, wherein the detector detects the rotational load of the fuser belt based on a rotation torque of the pressure roller.

8. The image forming apparatus according to claim 1, wherein the detector detects the rotational load of the fuser belt based on a cumulative number of rotations of the pressure roller.

9. The image forming apparatus according to claim 1, wherein the detector detects the rotational load of the fuser belt based on a cumulative number of sheets of the recording medium that passes through the nip portion.

10. A pressing force control method executed by an image forming apparatus,
the image forming apparatus including
a pressure roller,
a driving unit that drives rotation of the pressure roller,
an endless fuser belt,
a pressing member that is provided inside of the endless fuser belt to be opposite to the pressure roller and forms a nip portion where the fuser belt and the pressure roller come into contact with each other, and
a pressing force adjustment mechanism that adjusts a pressing force that presses one of the pressure roller and the pressing member to the other,
the method comprising:
a detection step of detecting a rotational load of the fuser belt; and
a pressure step of controlling the pressing force adjustment mechanism such that the pressing force is higher in an overload state where the rotational load of the fuser belt detected by the detection step is equal to or more than a predetermined value than in a normal state where the rotational load of the fuser belt is less than the predetermined value.

11. The pressing force control method according to claim 10, wherein the pressure step includes a step of controlling the pressing force adjustment mechanism such that the pressing force while the pressure roller accelerates or decelerates is higher than the pressing force in the normal state.

12. The pressing force control method according to claim 10, wherein the pressure step includes a step of controlling the pressing force adjustment mechanism such that the pressing force while a recording medium passes through the nip portion is higher than the pressing force in the normal state.

13. The pressing force control method according to claim 10, wherein the pressure step includes a step of causing the pressing force adjustment mechanism to start adjusting the pressing force before the pressure roller accelerates or at a same time as the pressure roller accelerates.

14. The pressing force control method according to claim 10, wherein the pressure step includes a step of causing the pressing force adjustment mechanism to start adjusting the pressing force before the pressure roller decelerates or at a same time as the pressure roller decelerates.

15. The pressing force control method according to claim 10, wherein the pressure step includes a step of causing the pressing force adjustment mechanism to continue the pressing force higher than the pressing force in the normal state for a predetermined time.

16. The pressing force control method according to claim 10, wherein the detection step includes a step of detecting the rotational load of the fuser belt based on a rotation torque of the pressure roller.

17. The pressing force control method according to claim 10, wherein the detection step includes a step of detecting the rotational load of the fuser belt based on a cumulative number of rotations of the pressure roller.

18. The pressing force control method according to claim 10, wherein the detection step includes a step of detecting the rotational load of the fuser belt based on a cumulative number of sheets of a recording medium that passes through the nip portion.

19. A non-transitory computer-readable recording medium encoded with a pressing force control program executed by a computer that controls an image forming apparatus,
the image forming apparatus including
a pressure roller,
a driving unit that drives rotation of the pressure roller,
an endless fuser belt,
a pressing member that is provided inside of the endless fuser belt to be opposite to the pressure roller and forms a nip portion where the fuser belt and the pressure roller come into contact with each other, and
a pressing force adjustment mechanism that adjusts a pressing force that presses one of the pressure roller and the pressing member to the other,
the pressing force control program causing the computer to execute
a detection step of detecting a rotational load of the fuser belt, and
a pressure step of controlling the pressing force adjustment mechanism such that the pressing force is higher in an overload state where the rotational load of the fuser belt detected by the detection step is equal to or more than a predetermined value than in a normal state where the rotational load of the fuser belt is less than the predetermined value.
